(19) United States
(12) Patent Application Publication
(10) Pub. No.: US 2007/0031017 A1
(43) Pub. Date: Feb. 8, 2007

(54) Method and arrangement for displaying time variable processes in medical imaging

(76) Inventor: Lutz Gundel, Erlangen (DE)

Correspondence Address: HARNESS, DICKEY & PIERCE, P.L.C., P.O.BOX 8910, RESTON, VA, 20195, US

(21) Appl. No.: 11/498,852

(22) Filed: Aug. 4, 2006

(30) Foreign Application Priority Data
Aug. 5, 2005 (DE) 10 2005 036 999.5

(51) Int. Cl. G06K 9/00; G06K 9/36

(52) U.S. Cl. 382/128; 382/276

(57) ABSTRACT

A method and an arrangement are disclosed for displaying time variable processes in medical imaging. In the case of the method, 2D or 3D image data obtained from an imaging modality are processed in order to produce a temporal sequence of images. Intermediate images that are displayed in temporal sequence with the images are generated by interpolation between temporally consecutive images. The processing of the 2D or 3D image data is performed, from which the images are transmitted to a display unit, in which the interpolation is carried out and which displays the images with the intermediate images. The present method and the associated arrangement permit a fluid display of the time variable processes on the display screen.

### PRIORITY STATEMENT

The present application hereby claims priority under 35 U.S.C. §119 on German patent application number DE 10 2005 036 999.5 filed Aug. 5, 2005, the entire contents of which is hereby incorporated herein by reference.

### FIELD

The present invention generally relates to a method and/or an arrangement for displaying time variable processes in medical imaging. For example, 2D or 3D image data obtained from an imaging modality may be processed in order to produce a temporal sequence of images, intermediate images may then be generated by interpolation between temporally consecutive images, and the images may then be displayed in temporal sequence with the intermediate images.

### BACKGROUND

Time variable processes that must be displayed to the user in a suitably processed fashion are frequently recorded in medical imaging. A distinction is made here between displaying two-dimensional images of the time variable processes and displaying three-dimensional images of the time variable processes. Two-dimensional images can be but are not limited to, for example, ultrasound images, perfusion images in the case of computer tomography (CT), images from CT fluoroscopy or pictures of magnetic resonance tomography (MR). Three-dimensional images can be but are not limited to, for example, pictures of the moving heart with the aid of different modalities, or images of the virtual endoscopy of hollow organs such as intestines, bronchi, ventricles or vessels by means of CT and MR, and also by use of ultrasound in the case of vessels.

After the recording of the measured data with the aid of the appropriate imaging modality, these data are firstly suitably processed, as a rule, in order to obtain 2D or 3D image data from these measured data. During imaging for the purpose of displaying time variable processes, a sequence of 2D or 3D image data records are obtained that have been acquired at different recording instants with the aid of the imaging modality. These image data records are subsequently further processed in order to obtain the imaging suitable for the user.

The result is two-dimensional images that are displayed on a display screen in temporal sequence. In this case, the image rate is determined by the processing algorithm, by the speed of the processing unit used for the processing, and, if the aim is to display in real time, by the data rate of the recording system of the imaging modality. Since the images are frequently displayed on one or more display units distributed arbitrarily in space, the image rate is also further restricted by the speed of the data link to these display units. As a result of this, the image rate is frequently not high enough to achieve a fluid display of the recorded temporal variations.

### SUMMARY

A method and an arrangement are specified, in at least one embodiment, for displaying time variable processes in medical imaging with the aid of which a more fluid display by comparison therewith can be achieved.

Advantageous refinements of embodiments of the method and of the arrangement can be gathered from the following description and the example embodiment.

In the case of a method of at least one embodiment for displaying time variable processes in medical imaging, the 2D or 3D image data obtained from an imaging modality are firstly processed in order to produce a temporal sequence of images in a representation suitable for the user. What is involved here is two-dimensional or three-dimensional processing, for example the generation of MPR images (MPR: Multi Planar Reformatting), or the compilation of a 3D volume image from 2D tomograms. Of course, other processing techniques that lead to the desired pictorial representations are also possible.

In order to raise the image rate during imaging, two techniques are combined in the case of at least one embodiment of the present method. Firstly, intermediate images that are subsequently displayed in the associated temporal sequence together with the images are generated by image interpolation between temporally consecutive images. It is possible thereby to generate one or more intermediate images between two images, and to display it or them. It is preferred in at least one embodiment, to carry out an interpolation of 0th or 1st order, it being possible, of course, to use any mathematical methods suitable for the interpolation, in particular including higher-level algorithms that require more than two consecutive images for the calculation.

Secondly, in addition to this interpolation, at least one embodiment of the present method also employs splitting of the method steps into at least two processing units. The processing of the 2D or 3D image data—on the basis of all input image data—is performed in a processing unit that acts as server and transmits the resulting images to the display unit acting as client. Just like the display, the interpolation of the intermediate images is then performed by the display unit. This splitting up minimizes the quantity of data to be transmitted to the display unit for imaging. The data can thus be transmitted more quickly, and so the image rate is restricted to a lesser degree by the data transmission rate.

The quantity of data to be transmitted can thereby both be lower than the quantity of data of the input image data that arises for the original processing, and also smaller than the quantity of data occurring for imaging by interpolation of the intermediate images.

The associated arrangement includes at least one processing unit as server that comprises a memory unit for storing 2D or 3D image data as well as a processing module for generating a temporal sequence of images from the 2D or 3D image data, and, as client, a display unit, connected to the processing unit via a data link, that comprises an interpolation module for generating intermediate images from the images transmitted by the processing unit, and a display module for displaying the images and intermediate images. The display module can comprise, for example, a graphics card with a connected image monitor. Given the use of an intelligent graphics card, the interpolation can also be performed on the graphics card, which then comprises both the display module and the interpolation module. Processing module and interpolation module in each case require a microprocessor for processing the image data and for calculating the intermediate images.

### BRIEF DESCRIPTION OF THE DRAWINGS

The present invention and the associated arrangement are explained below once more in greater detail with the aid of an example embodiment in conjunction with the drawings and without limitation to the scope of protection prescribed by the patent claims. In the drawings:

FIG. 1 shows two examples of a temporal sequence of two-dimensional or three-dimensional image data;

FIG. 2 shows a schematic of the basic principle used in carrying out at least one embodiment of the present method;

FIG. 3 shows a schematic of the image interpolation in the case of at least one embodiment of the present method; and

FIG. 4 shows a schematic of the present arrangement.

### DETAILED DESCRIPTION OF THE EXAMPLE EMBODIMENTS

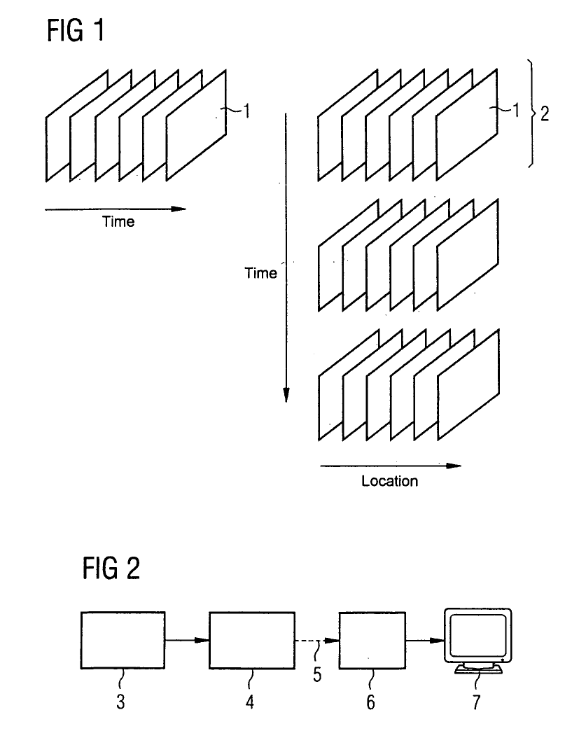

FIG. 1 shows in the left-hand part an example of two-dimensional image data records 1, for example fluoroscopic image data, that have been recorded in temporal sequence in order to be able to detect time variable processes in the images. In the right-hand part of the figure, the same situation is shown with the aid of 3D image data records 2 that are composed in each case as a rule from a number of 2D image data records, in particular from spatially separated tomograms of the examination object. Here, as well, a temporal sequence of the 3D image data records 2 results for the observation of time variable processes.

Of course, the 3D image data can also be obtained by way of a volume detector that supplies 3D image data of the entire volume instead of individual tomograms.

The principle of the mode of procedure in the case of at least one embodiment of the present method is briefly explained with the aid of FIG. 2. After the recording, preprocessing and, if appropriate, reconstruction in the first method step 3, the 2D or 3D image records are subjected in the second method step 4 to a two-dimensional or three-dimensional processing. The result of this processing, for example for the purpose of generating specific views such as MPR, is two-dimensional images that can be displayed on a display screen 7.

In the case of at least one embodiment of the present method, these images are transmitted by a server, on which this processing is performed, via a data link 5 to a client where the imaging is performed on the display screen 7. At this client, the images obtained via the data link 5 are interpolated 6. During this interpolation 6, intermediate images that are subsequently displayed on the display screen 7 in correct temporal sequence with the original images are generated between in each case two consecutive images. The image rate is thereby raised such that a fluid time profile of the imaging or of the time variable processes displayed thereby is achieved.

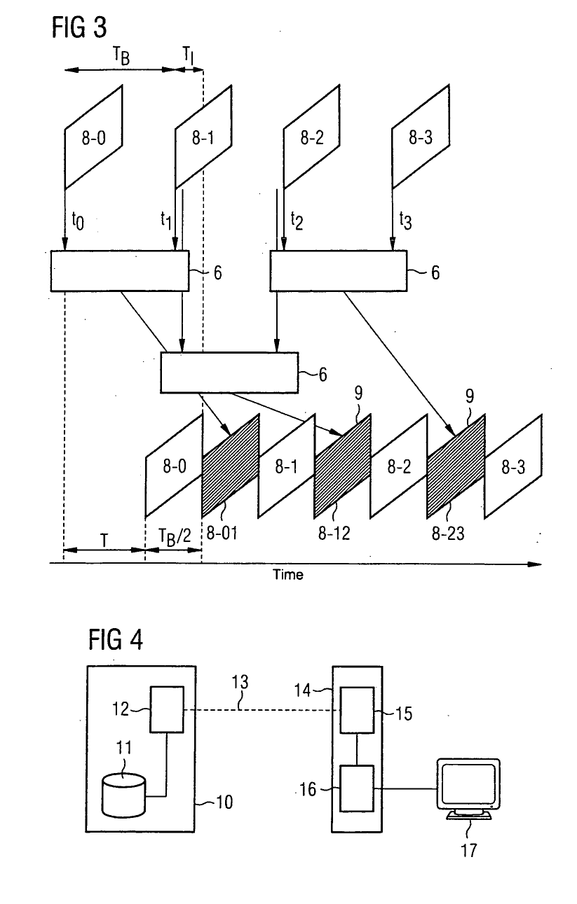

FIG. 3 shows to this end a schematic of an example of image interpolation. For this purpose, the image 8-01 is calculated from the images 8-0 and 8-1, the image 8-12 is calculated from the images 8-1 and 8-2, etc. by interpolation of 0th or 1st order, and output between the images 8-0 and 8-1 or 8-1 and 8-2, respectively. In this example, the overall result is a doubling of the image rate as is to be seen in the lower part of the figure. The calculation of the image 8-01 cannot be performed until the image 8-1 is present at the input of the interpolation module.

Moreover, the interpolation itself requires a specific time. This results in a delay time T that is determined from the sum of the image period before the interpolation TB and the computing time of the interpolator T_{I} as T=T_{B}/2+T_{I}. This delay time must remain clearly below 1 s in the case of real time methods, for example in the case of CT fluoroscopy, so that it cannot be perceived subjectively by the user. This subjective threshold is likewise to be borne in mind in the case of interactive methods. Of course, it is also possible to use other mathematical methods for the interpolation. However, higher-level algorithms require more than two neighboring images or slices, and so the delay time is further lengthened thereby.

In the case of at least one embodiment of the present method, use is made of an arrangement such as may be seen schematically from FIG. 4. This arrangement includes a processor unit 10 as server, and a display unit 14 as client. Server and client are interconnected via the data link 13. A memory unit 11 for storing the 2D or 3D image data of the imaging modality is provided in the processing unit 10. A processing module 12 reads the data from this memory unit 11 and processes them in accordance with the stipulations made by the user. The images generated by the processing module 11, or their data, are transmitted via the data link 13 to the interpolation module 15 of the data processing unit 14. After the interpolation of intermediate images, the images and intermediate images are displayed by the display unit 16 on a display screen 17 of the display unit.

This arrangement and the associated method have the advantage that the quantity of data obtained from the imaging modality is initially stored on the server and need not be transferred to the client in a time-consuming fashion. The application is split into a server part and a client part. The server part, in the processing module, accesses the data and processes them in accordance with the application. Only the result is then transmitted to the client and interpolated and displayed there.

This splitting is particularly advantageous when the data rate of the images generated by the processing unit is much slower than the required input rate of the algorithm. Since the image interpolation is performed in the interpolation module at the client end, there is also no burden imposed on the data link by the quantities of data additionally generated thereby. This ensures that by comparison with known methods substantially fewer data need be transmitted to the client. This proves to be particularly advantageous in the case of connections with a restricted data rate such as are frequently offered by hospital networks or network connections via the public telephone network.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for displaying time variable processes in medical imaging, the method comprising:
processing at least one of 2D and 3D image data, obtained from an imaging modality, in a processing unit to produce a temporal sequence of images of a time variable process;
transmitting the temporal sequence of images to a display unit;
generating intermediate images, not previously present, in the display unit by interpolation using temporally consecutive images; and
displaying the temporal sequence of images with the intermediate images at the display unit.

2. The method as claimed in claim 1, wherein the images are transmitted from the processing unit to the display unit via at least one of a wired and wireless network connection.

3. An arrangement for displaying time variable processes in medical imaging, comprising:
a processing unit including a memory unit to store at least one of 2D and 3D image data of a time variable process and a processing module to generate a temporal sequence of images of the time variable process from the at least one of 2D and 3D image data; and
a display unit, connected to the processing unit via a data link, including an interpolation module to generate intermediate images, not previously present, from the temporal sequence of images received from the processing unit, and a display module to display the received images and intermediate images.

4. The arrangement as claimed in claim 3, wherein the data link is at least one of a wired and wireless network connection.

5. An arrangement for generating time variable processes in medical imaging, comprising:
first means for processing at least one of 2D and 3D image data, obtained from an imaging modality, to produce a temporal sequence of images of a time variable process; and
second means, connected to the first means via a data link, for generating intermediate images for display, not previously present, from the temporal sequence of images received from the first means.

6. The arrangement as claimed in claim 5, wherein the second means is further for displaying the received images and intermediate images.

7. The arrangement as claimed in claim 5, wherein the first means includes means for storing the at least one of 2D and 3D image data, obtained from an imaging modality, and means for processing to produce a temporal sequence of images of a time variable process.

8. The arrangement as claimed in claim 6, wherein the first means includes means for storing the at least one of 2D and 3D image data, obtained from an imaging modality, and means for processing to produce a temporal sequence of images of a time variable process.

9. The arrangement as claimed in claim 5, wherein the data link is at least one of a wired and wireless network connection.

10. The arrangement as claimed in claim 6, wherein the data link is at least one of a wired and wireless network connection.

11. The arrangement as claimed in claim 7, wherein the data link is at least one of a wired and wireless network connection.

12. The arrangement as claimed in claim 8, wherein the data link is at least one of a wired and wireless network connection.
